(19) United States
(12) Patent Application Publication
(10) Pub. No.: US 2026/0077961 A1
(43) Pub. Date: Mar. 19, 2026

(54) BELT BUFFER FOR A PRODUCT CONVEYING DEVICE

(71) Applicant: Rotzinger AG, Kaiseraugst (CH)

(72) Inventor: Kurt Philipp, Grenzach-Wyhlen (DE)

(21) Appl. No.: 19/103,001

(22) PCT Filed: Aug. 10, 2023
(86) PCT No.: PCT/EP2023/072131

§ 371 Date: Feb. 11, 2025

(30) Foreign Application Priority Data
Aug. 17, 2022 (EP) 22190836.1

(51) Int. Cl. B65G 47/52

(52) U.S. Cl. CPC B65G 47/52

(57) ABSTRACT

The invention relates to a belt buffer for a product conveying device which conveys products (13) from a production facility by means of conveyor belts (1, 2) to at least one further processing facility. The belt buffer has at least two buffer belts, which store products (13) and are arranged vertically one above the other. The buffer belts have, on the inlet side, a first vertically pivotable belt deflector (5) for optionally connecting to an inlet belt (3) and, on the outlet side, a second vertically pivotable belt deflector (6) for optionally connecting to an outlet belt (4). The belt buffer can convey the products (13) through the buffer in a first-in first-out process.

### TECHNICAL FIELD OF THE INVENTION

The invention relates to a belt buffer for a product conveying device, a product conveying device comprising such a belt buffer, and a method for temporarily storing products by means of such a belt buffer. In particular, the invention relates to a belt buffer and a product conveying device for piece goods from the food industry that are to be processed promptly.

### PRIOR ART

When manufacturing piece goods using production lines, it is common practice to use buffers to decouple processes and increase efficiency. In this case, quality standards must be taken into account, particularly in the food industry. In the production lines, the piece goods produced in rows are transferred from a production plant, such as a furnace or a casting system, with a wide main belt and are supplied over a short path to a packaging system. These are for example biscuits, chocolate bars, or candy bars.

Depending on the production capacity, a plurality of packaging lines is needed to pack a produced quantity with the lowest possible scrap rate. In this case, a packaging line consists of a plurality of series-connected packaging machines such as, for example, a tube packaging machine in first place, a multipack machine in second place, a cartoner in third place, and finally a palletizer. If one of the machines in this line stops due to a malfunction, then the whole line fails. In order to prevent overflow from occurring during constant production, either an additional, so-called standby packaging line must jump in, or a buffer receives the excess products so that overflow of products (waste) can be avoided.

Belt buffers are known from the prior art which are located at the end of a feed line and can thus absorb the overflow of product rows that cannot be allocated to the upstream packaging machines. An overflow of product lines can occur if the packaging lines to be fed by the supply line are stopped and thus the supplied product lines cannot be allocated. Cross-discharge stations known from the prior art are used to allocate the product rows, which stations can always remove the next product row from the continuously fed flow upon request of the relevant packaging line. In this case, the product rows arriving on the main belts are conveyed to a cross-discharge belt arranged below the conveyor level of the main belts.

This cross-discharge belt is arranged transversely to the main conveying direction and conveys the product rows towards the packaging machines. In order to generate a seamless, continuous product flow to the packaging machines, a plurality of short gap-closing belts is installed downstream of the cross-discharge belt. The previously mentioned allocation of the product rows to the packaging lines in the cross-discharge station is usually carried out by a combined lowering and retraction movement of the outlet-side belt nose of the main belt of the cross-discharge station. A typical feed line comprises a line head station, subsequent cross-discharge stations connected in series, and a belt buffer at the end of the line to accommodate the overflow of product rows.

In this case, the freshly produced product lines are taken over from the production plant in a synchronized manner at the line head and separated from one another with short belts and transferred into a regular, continuous product flow. In addition, the product rows are recorded and inspected using sensors that measure their length, height and distance from the neighboring product row. In addition, the product rows can still be aligned and checked for metal contamination. Unacceptable rows are ejected via a retraction movement or a vertical pivoting movement of the outlet-side belt nose of a main belt in the line head onto an ejection belt located below and transverse to the main conveying direction. All product rows that cannot subsequently be allocated to the packaging machines by the downstream cross-discharge stations are then fed as overflow to the belt buffer arranged at the end of the row.

These belt buffers from the prior art work according to the first-in last-out principle (FiLo principle). Such a belt buffer is known, for example, from WO 2022/117606 A1. In this case, all buffer belts are designed to be reversible, i.e., when picking up product rows, the buffer belts run in the main conveying direction and when releasing product rows, they run against (reverse) the main conveying direction. Here, the receiving of product rows means storing them and the release of product rows means removing them from the buffer. This also means that the supply and discharge of the belt buffer are located in the inlet region of the belt buffer.

These belt buffers at the end of the feed line consist of single or multi-layered stationary main belts, which must be operated reversibly as buffer belts. These buffer belts, which are arranged vertically one above the other, are usually served via a vertically pivoting main belt and connected to the upstream feed system. This belt must also be able to be operated reversibly in the main conveying direction and against the main conveying direction. These buffer belts at the end of the line are typically arranged one above the other in a fan shape. Thus, the belts located above the feed level have an upward gradient of up to 10° and the belts located below the feed level have a downward gradient of up to 10°. This means that the inlets of these buffer belts can be arranged with a small vertical distance from one another, so that the upstream pivotable main belt can then supply the various buffer levels with product rows with a short vertical stroke even at high row outputs.

A main requirement for such a first-in last-out belt buffer is the return of product rows during production against the main conveying direction to the directly upstream packaging lines. The regular return of product rows from the belt buffer to the upstream packaging lines is called “refeed” in technical jargon. This refeed is used to empty the belt buffer. This can counteract the threat of overfilling as the belt buffer fill level increases. Typically, the refeed rate is coupled with the filling level of the belt buffer. The higher the fill level, the higher the refeed rate. For the refeed, gaps must be systematically generated in the incoming product flow, into which the refeed rows must then be allocated to the packaging line upstream of the belt buffer. As an experience value, a refeed rate of at least 20% is required to empty the belt buffer within a reasonable time. In this case, the refeed quota is the excess capacity of the installed packaging capacity in relation to the production capacity. The installed packaging capacity is the sum of the capacity of all packaging lines.

A disadvantage of these belt buffers at the end of the line is the system-related operation according to the FiLo principle. This means that the first stored product rows are the last to be put back into the packaging via the refeed process. In reality, this often means that the products remain unpackaged in storage for hours, which is not conducive to product quality and product safety. In addition, the buffer belts for storing and retrieving must be operated in cycles and reversibly. Since the buffer belts are arranged geometrically at an angle, as described above, the product rows have much less friction on the belt surface. In combination with the reversing cycle operation of the buffer belts, the products can slip very easily. This in turn leads to subsequent disruptions and product loss.

It is therefore the object of the present invention to provide a belt buffer for a product conveyor and a method for temporarily storing products during processing, which ensure product quality and safety, allow timely processing of products, and allow a flexible design of the product conveyor. In particular, the belt buffer should be usable at the end of the line as well as at the beginning of the line of a product conveying device and should be integrated into the product flow in such a way that the disadvantages described can be avoided.

### SUMMARY OF THE INVENTION

According to the present invention, this object is achieved by a belt buffer according to claim 1, a product conveying device according to claim 11, and a method for temporarily storing products according to claim 14. Advantageous embodiments and different embodiments of the invention can be found in the dependent claims.

A belt buffer according to the present invention, which is designed for a product conveying device that conveys products from a production plant by means of conveyor belts to at least one further processing plant, has at least two buffer belts for storing products. The products are available, for example, in the form of piece goods and are arranged in product rows, which can be spaced apart from one another according to the requirements of the product conveying device and the further processing plant. The buffer belts are designed in particular to store products that cannot be picked up by a further processing plant. The at least two buffer belts are arranged vertically one above the other. Each of the buffer belts has a vertically pivoting belt deflector for optional connection to a conveyor belt to pick up products. According to the invention, the buffer belts each have a first vertically pivotable belt deflector on the inlet side for optionally connecting to an inlet belt, and a second vertically pivotable belt deflector on the outlet side for optionally connecting to an outlet belt. According to the invention, a buffer level is provided by a single buffer belt. The buffer belt extends from the inlet to the outlet. Each of the buffer belts has a first vertically pivotable belt deflector on the inlet side for optional connection to the inlet belt, and a second vertically pivotable belt deflector on the outlet side for optional connection to the outlet belt. The belt deflectors of the buffer belts are designed as flat wings, which can be pivoted at one end about a horizontally extending stationary pivot axis. The other end of the wings, or the belt deflectors, is thus free and can be pivoted vertically up and down to connect to an inlet or outlet belt. The inlet belt and the outlet belt can serve as conveyor belts for transporting the products along a production line of the product conveying device, the products being guided along the production line in a main transport direction from the production plant to a further processing plant, in particular to a packaging plant. Advantageously, the belt buffer itself can have an inlet belt and an outlet belt, the inlet belt being provided with the first vertically pivotable belt deflector and the outlet belt being provided with the second vertically pivotable belt deflector.

The buffer belts arranged one above the other are essentially identical. They each have a horizontal stationary conveyor chassis, on one side of which the inlet-side belt deflector and on the other side of which the outlet-side belt deflector are pivotally mounted. Such an arrangement allows the decoupling of the outflows at the inlet and outlet, even if the buffer levels consist of only one buffer belt. The inlet-side and outlet-side belt deflectors are essentially identical in design, in particular they are of the same length. The buffer belts are advantageously designed to be mirror-symmetrical relative to a central axis of their conveyor chassis. The free ends of the belt deflectors are designed in a known manner to facilitate product pickup or product release. The length of the conveyor chassis can be adapted to given spaces or desired buffer capacities and dwell times. The length of the belt deflectors can be adapted to specifications regarding a maximum permissible inclination of the buffer belts.

According to a method according to the invention for temporarily storing products during product conveyance by the product conveying device, a product inlet into the belt buffer and a product outlet from the belt buffer takes place on different buffer belts arranged vertically one above the other. This means that while products are fed from the inlet belt to a first belt buffer, products at the product outlet are discharged from another, second belt buffer to the outlet belt. This results in a decoupling of the product inlet from the product outlet and maximum flexibility in the allocation of products delivered to buffer belts, independent of the removal of the products from the belt buffer. In principle, it is quite conceivable that feeding and removal can take place via the same buffer belt. In this case, the buffer belt is comparable to a conveyor belt for product transport. A certain buffer function can be achieved by shortening product distances on the buffer belt compared to product distances on the inlet belt. However, the buffer capacity is lower in this case. The selection of the supplied buffer belt and the discharge buffer belt can be carried out by means of a controller of the belt buffer or the product conveying device. The controller regulates the pivoting of the belt deflectors and ensures that a free end of an inlet-side belt deflector is leveled with the inlet belt or a free end of an outlet-side belt deflector is leveled with the outlet belt.

The belt buffer according to the invention makes it possible to feed stored products to a further processing plant according to the first-in first-out principle (FiFo principle). The belt buffer can be flexibly integrated into the product flow. It can be positioned at the beginning of the line, in the middle of the line or at the end of the line. Especially at the end of the line, the proposed belt buffer concept is advantageous in terms of product quality and safety and product handling due to the FiFo principle. Excessively long residence times of the products in the belt buffer are avoided by the FiFo principle. Due to the multi-layer design of the buffer belts and the integration of the belt deflectors at the inlet and outlet, the belt buffer has a short overall length but still a high buffer capacity.

Different designs of the belt buffer can be provided with different numbers of buffer belts, depending on the required buffer capacity. As a minimal design, only two buffer belts are provided. Advantageously, four buffer bands are used to increase the capacity of the storage. However, more than four, for example six, seven or eight buffer belts can be integrated. It is essential that the inclination of the buffer belts does not become too great when picking up and releasing products in order to avoid the products slipping out of the buffer belts.

Furthermore, the belt buffer can have two inlet belts and/or two outlet belts, each arranged vertically one above the other, each of the inlet belts and/or the outlet belts being connectable to one of the inlet-side belt deflectors or the outlet-side belt deflectors arranged one above the other. In this way, the band buffer can, for example, store products from two different production facilities or different production lines.

In an advantageous embodiment of the belt buffer according to the present invention, the inlet-side belt deflector and the outlet-side belt deflector can be controlled independently of one another. Accordingly, for example, only storage can take place initially, without the need for removal at the same time. A plurality of buffer belts can be filled first before storage is initiated. Storage and retrieval can also take place at the same time. In addition, the speeds of the products on the buffer belts can be controlled independently during storage and removal, and the cycle interval of the products can be adapted to the requirements of the further processing plant.

In a further embodiment of the belt buffer according to the invention, at least two belt deflectors arranged vertically one above the other are coupled to one another. Therefore, the number of pivot drives for pivoting the belt deflectors relative to one another and the control of the belt deflectors can be reduced. The coupling can be done mechanically, for example by means of coupling struts which connect the belt deflectors arranged one above the other in an articulated manner, or by means of an electronic coupling via the controller. Subgroups of belt deflectors can also be coupled together on the inlet side and/or the outlet side. For example, in the case of four buffer belts, the upper two belt deflectors and the lower two belt deflectors can be coupled, it being possible for the upper one to be independent of the lower one. This allows for flexible use of the belt buffer and also efficient operation.

In yet another embodiment of the belt buffer according to the invention, the inlet belt, the buffer belts and the outlet belt are arranged in series one behind the other. It is advantageous if the inlet belt and the outlet belt are arranged on the same level. The inlet belt, buffer belts and outlet belt are thus aligned along a main transport direction of the product conveyor. The products can be delivered from the discharge belt to conveyor belts of the product conveying device in the same transport direction. Thus, an inlet conveyor direction from the production plant corresponds to an outlet conveyor direction to the further processing plant. This creates a continuous product flow without the need to reverse the transport movement of the buffer belt, the discharge belt or the subsequent conveyor belt. It is not necessary to store or retrieve products against the main transport direction. This variant is used, for example, when the belt buffer is positioned at the beginning or in the middle of a product line.

In another product conveying device, the belt buffer can be located at the end of the conveyor line behind the production line and behind product discharge stations, which divert products from the conveyor line to a further processing line. In this embodiment, an outlet conveying direction from the belt buffer is provided opposite to an inlet conveying direction into the belt buffer. At least one of the buffer belts and the discharge belt can be designed to be reversibly driven. Advantageously, the lowest buffer belt is designed to be reversible, whereby the reversed products can be stored below the other buffer belts and below the inlet belt. However, any of the other existing buffer belts for returning products can also be designed to be reversible. This embodiment is used, for example, when the belt buffer is positioned at the end of a product line and the products are to be transported back to conveyor belts against the main transport direction, which take the products to the further processing systems.

In this case, the products are discharged from the inlet belt onto one of the upper buffer belts in the main transport direction and conveyed over this buffer belt in the main transport direction. As soon as this buffer belt is full and products need to be removed, products are discharged onto the discharge belt at the opposite end of the buffer belt. The discharge belt initially runs in the main transport direction to pick up one or more rows of products. To return the products to the product line, the direction of movement of the discharge belt is reversed and the products can be discharged onto the reversible bottom buffer belt. On the buffer belt, the products run against the main transport direction towards the inlet belt. At the end of the buffer belt, the products can be delivered to a conveyor belt of the product conveying device, which, for example, belongs to a discharge station and discharges the products from the production line to a further processing plant. It is also possible for the inlet belt to be reversible. In this case, the products returned from the lowest buffer belt can be picked up by the inlet belt in their reversed direction of movement. They can then, for example, be fed to another buffer belt in the main transport direction, so that the product passes through the belt buffer again, or it can, for example, be discharged to a further processing plant via a discharge station.

Due to the reversibility of at least the outlet belt and one of the buffer belts, the belt buffer can be flexibly positioned in the production line without having to forgo the FiFo principle for storing the products. Furthermore, constant reversing on the buffer belts to achieve the desired timing of the products can be avoided. A clocked reversing is reduced to the outlet belt and, if necessary, the inlet belt. However, since these belts are horizontal, the jerky reversing operation is not as critical as with the inclined belts of the belt deflectors, since the adhesion of the products on the horizontal belts is maximum. This greatly reduces the risk of products slipping and thus increases the efficiency of the belt buffer.

In an additional embodiment of the belt buffer according to the invention, pivotable regions of the buffer belts, which are arranged below a level of the inlet belt and/or the outlet belt, are designed as autonomous, i.e., separate, conveyor belts. At least the pivotable regions of the belt deflectors of these buffer belts are designed as pivotable conveyor belts. This can support the active conveying of the products on an ascending belt deflector.

In one embodiment of the belt buffer according to the present invention, the inlet-side belt deflectors can be pivoted vertically over the inlet belt. Thus, none of the buffer belts are connected to the inlet belt, and a gap is created between the end of the inlet belt and the ends of the buffer belts. Product waste or overproduction can be eliminated from the product line through this gap.

In summary, in the method for temporarily storing products during product conveyance by a product conveying device according to the present invention, a product inlet into the belt buffer and a product outlet from the belt buffer of different buffer belts arranged vertically one above the other takes place. In this case, products can be fed to the belt buffer via the inlet belt in one conveying direction to an inlet-side belt deflector of a belt buffer, and products from another buffer belt can be discharged via the outlet-side belt deflector of this other buffer belt via the outlet belt in the same or opposite conveying direction. Storing into the belt buffer and retrieving from the belt buffer can be controlled independently.

### BRIEF DESCRIPTION OF THE FIGURES

The invention is represented below by means of the figures, which are intended only for the purpose of explanation and are not to be interpreted restrictively. Features of the invention disclosed in the figures are intended to be considered as being part of the disclosure of the invention both individually and in any combination. In the drawings:

FIG. 1 is a three-dimensional schematic representation of a first embodiment of a belt buffer according to the present invention,

FIG. 2 is a side view of the first embodiment of the belt buffer of FIG. 1,

FIG. 3 is a detailed view of an inlet region of the belt buffer from FIG. 1,

FIG. 4 is a detailed view of belt deflectors arranged one above the other in the inlet region of the belt buffer from FIG. 1,

FIG. 5 is a schematic side view of a second embodiment of a belt buffer according to the present invention,

FIG. 6 is a schematic representation of a third embodiment of a belt buffer according to the present invention,

FIG. 7 is a schematic side view of a fourth embodiment of a belt buffer according to the present invention, and

FIG. 8 is a schematic side view of a fifth embodiment of a belt buffer according to the present invention.

### PREFERRED EMBODIMENTS OF THE INVENTION

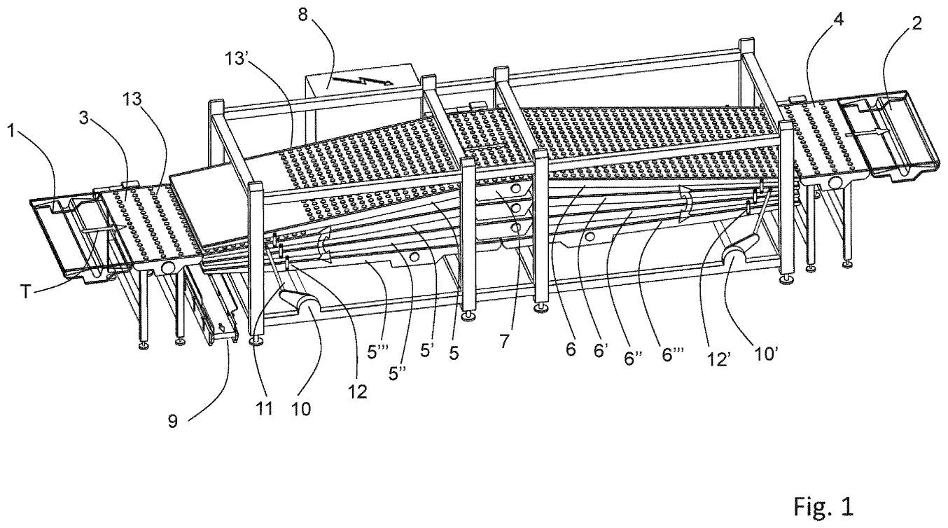

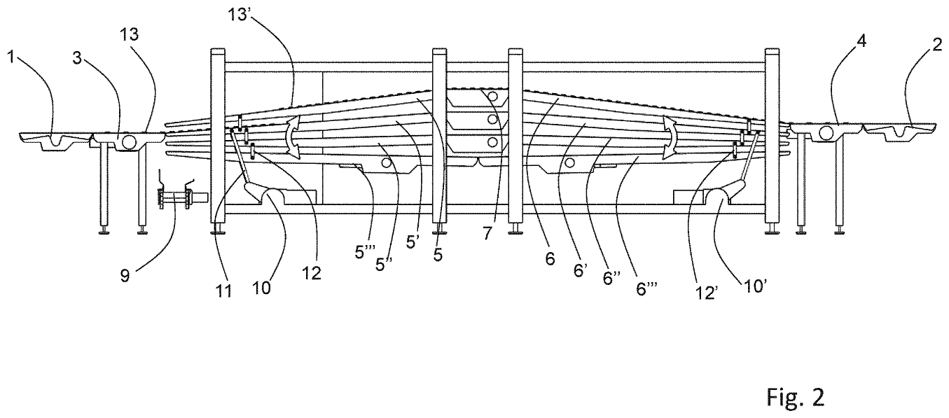

FIGS. 1 and 2 show a first embodiment of a belt buffer according to the present invention, which is designed for a product conveying device that conveys products along a conveyor line from a production plant by means of conveyor belts 1 and 2 to at least one further processing plant. In this embodiment, the belt buffer has an inlet belt 3, four buffer belts arranged vertically one above the other, which can store products from the conveyor line, and an outlet belt 4. It is important to note that the belt buffer may not have an inlet belt 3 or an outlet belt 4. Each of the buffer belts has a first vertically pivotable belt deflector 5, 5′, 5″ or 5′″ on the inlet side for optionally connecting to the inlet belt 3 and a second vertically pivotable belt deflector 6, 6′, 6″ or 6′″ on the outlet side for optionally connecting to the outlet belt 3. The buffer belts each have a horizontal stationary chassis 7, on which the belt deflectors are pivotally mounted at one end. A control unit 8 is installed next to the buffer belts and serves to control and supply power to the belt buffer. The control unit 8 can be connected to a central controller of the product conveying device. The inlet-side belt deflectors 5 and the outlet-side belt deflectors 6 can be controlled independently of one another.

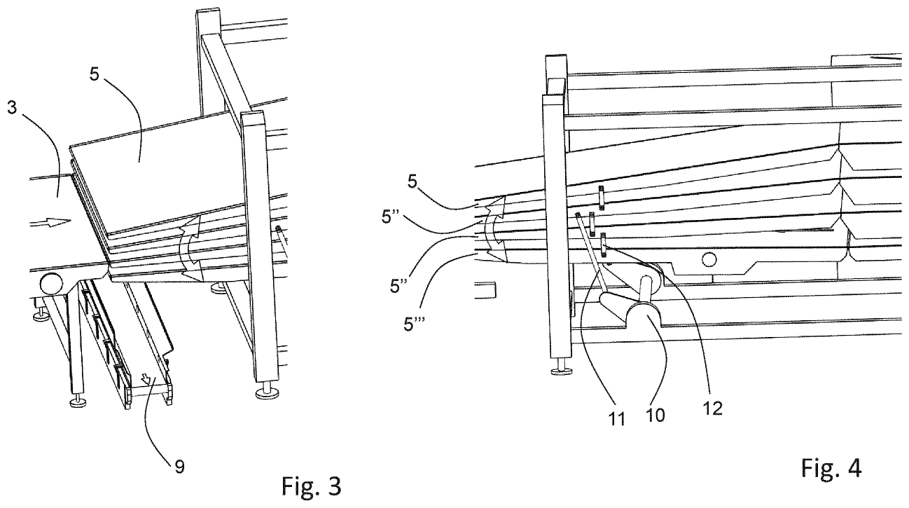

As can be seen in FIG. 3, a discharge belt 9 is provided in the inlet region below the end of the inlet belt 3, which runs transversely to a main transport direction of the conveyor line according to arrow T. Products delivered from the inlet belt 3 that are not picked up by one of the inlet-side belt deflectors 5 can be discharged by the discharge belt 9.

For this purpose, all four inlet-side belt deflectors 5 are pivoted upwards above the level of the inlet belt 3 so that none of the belt deflectors are connected to the inlet belt and a gap 14 is created (see FIG. 5).

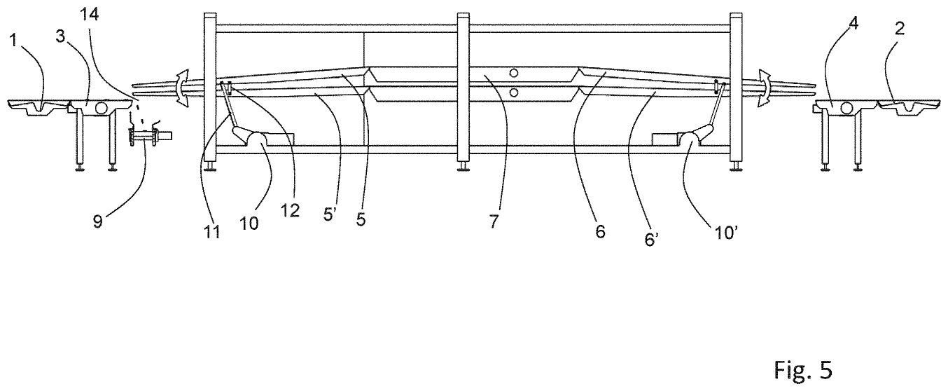

FIG. 4 shows a drive 10 and a coupling of the inlet-side belt deflectors 5. In this embodiment of the belt buffer, the drive 10 is designed as a crank drive which drives the belt deflectors via a lifting mechanism 11. The lifting mechanism includes, for example, a drive shaft with a lever and crank rod, it being possible for the drive shaft to be driven by a gear motor. In principle, other drives can also be used to pivot the belt deflectors. The belt deflectors are coupled to one another by means of coupling struts 12 so that all four belt deflectors 5 on the inlet side can be pivoted simultaneously. In an analogous manner, a drive 10′ and coupling struts 12′ are provided for the belt deflectors on the outlet side, which are essentially mirror-symmetrical to the drive 10 and the coupling struts 12.

As can be seen in FIG. 1, the inlet belt 3, the buffer belts and the outlet belt 4 are arranged in series one behind the other. The inlet belt 3 and the outlet belt 4 are arranged on one level. Products 13 are guided in spaced rows by means of the inlet belt in the transport direction T to the inlet-side belt deflectors. In the illustrated operation of the belt buffer, the products 13 are fed to the second highest inlet-side belt deflector 5′ and transferred from there to the second highest buffer belt. At the same time, products 13′, which are temporarily stored on the uppermost buffer belt, are delivered from the uppermost outlet-side belt deflector 6 onto the outlet belt 4 and conveyed in the main transport direction T by the conveyor belt 2 to a further processing plant. This means that products enter the belt buffer and exit the belt buffer from different buffer belts arranged vertically one above the other. The products are thus conveyed through the belt buffer according to the FiFo principle.

FIG. 5 shows a second embodiment of a belt buffer according to the invention, which, in contrast to the first embodiment, comprises only two buffer belts. The inlet-side belt deflectors and the outlet-side belt deflectors are each coupled to one another, as described in FIG. 4 for the first embodiment. In the method step shown in FIG. 5, the inlet-side belt deflectors 5 are pivoted upwards above the plane of the inlet belt 3, so that a gap 14 is created between the end of the inlet belt 3 and the inlet-side belt deflectors 5. Products 13 conveyed by the inlet belt 3 fall downwards onto the discharge belt 9 and are discharged. A belt buffer with only two buffer belts is useful, for example, for small production quantities or slow production processes, as it has a simple structure.

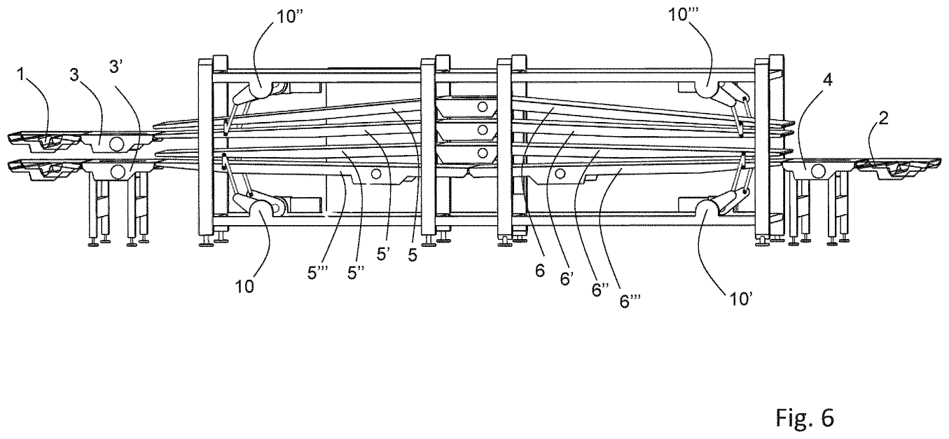

FIG. 6 shows a third embodiment of a belt buffer according to the invention, which has four buffer belts, two inlet belts 3 and 3′ arranged one above the other and an outlet belt 4. In contrast to the first embodiment, the inlet-side belt deflectors 5 and the outlet-side belt deflectors 6 are combined into subgroups with a common drive. The two lowest belt deflectors 5″ and 5′″ on the inlet side are combined by a drive 10. The two uppermost belt deflectors 5 and 5′on the inlet side are combined by a 10″ drive. The two lowest belt deflectors 6″ and 6′″ on the outlet side are combined by a drive 10′. And the two uppermost belt deflectors 6 and 6′ on the outlet side are combined by a drive 10′″.

This embodiment of the belt buffer can be advantageously positioned at the end of a product line. The outlet belt 4, the lowest buffer belt and at least the lower inlet belt 3′ can be designed to be reversible. Products that are delivered via the upper or lower inlet belt are preferably stored on one of the three upper buffer belts. As soon as one of these buffer belts is completely filled with products, they can be delivered to the outlet belt 4. As soon as a product formation of, for example, four product rows is deposited on the outlet belt 4, the direction of the discharge belt 4 can be reversed and the product formation can be delivered to the lowest buffer belt, which conveys the product formation against the main transport direction to the inlet region. There, the product formation can be delivered to the lower inlet belt 3′, from which it is conveyed further to a further processing plant or to another belt deflector 5, 5′ or 5″. In this embodiment, too, the products are conveyed through the belt buffer according to the FiFo principle.

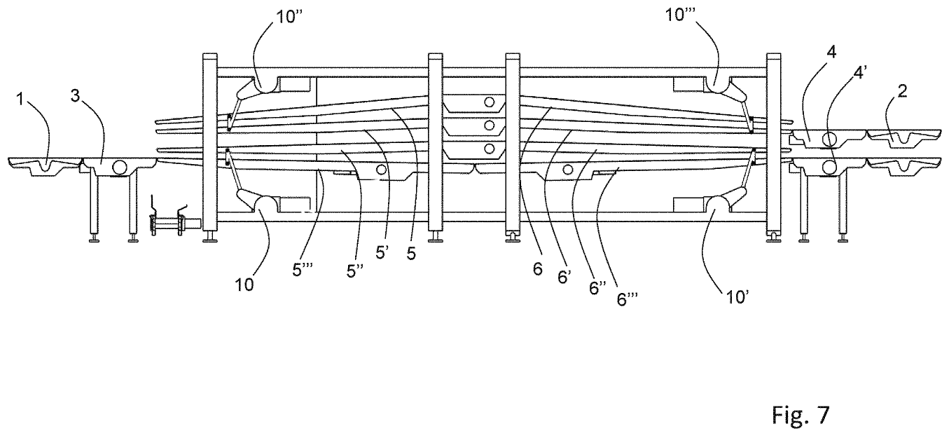

FIG. 7 shows a fourth embodiment of a belt buffer according to the invention with four buffer belts, which are designed analogously to the third embodiment. Furthermore, an inlet belt 3 and two outlet belts 4 and 4′ arranged one above the other are provided. In this embodiment, products can be fed to two discharge belts at the same time, which allows the belt buffer to be emptied more quickly.

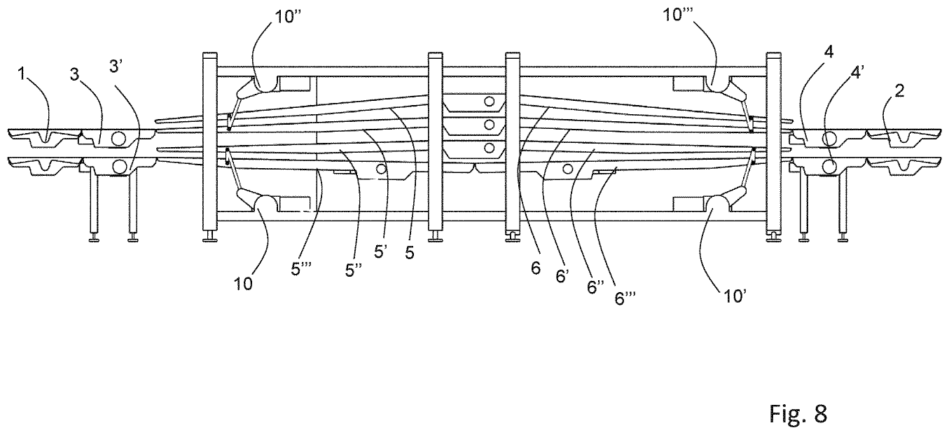

FIG. 8 shows a fifth embodiment of a belt buffer with four buffer belts, which forms a combination of the third and fourth embodiments. Two inlet belts 3 and 3′ arranged one above the other and two outlet belts 4 and 4′ arranged one above the other are provided. This design is suitable, for example, as a belt storage system for two connected production lines. For example, with this embodiment, product rows can be picked up from a plurality of inlet levels and delivered to a plurality of outlet levels simultaneously.

In summary, the belt buffer according to the present invention consists of at least two or more buffer belts arranged one above the other, the inlet-side and outlet-side end deflections 5 and 6 of which are wing-shaped. Each wing is mounted in the relevant stationary buffer belt chassis 7 and can thus pivot vertically about this bearing point. These wing-shaped belt deflectors 5 and 6 are connected to one another in an articulated manner by the couplings 12, are driven in a vertically pivotable manner, for example, via a crank drive 10 and thus form a belt switch with a plurality of levels at the inlet and outlet of the belt buffer.

If the lower buffer belt levels are located below the inlet/outlet level, then the pivoting belt deflectors 5 and 6 of these buffer belt levels at their inlet and outlet consist of autonomous conveyor belts. In a longer version of the belt buffer, an intermediate belt is arranged on these lower buffer belt levels.

At the inlet of the belt buffer, the pivoting belt deflectors of the buffer belts can be moved upwards so far that a gap 14 is created to the inlet level of the inlet belt 3, through which defective product rows can then be ejected downwards onto an ejection belt 9 located transversely to the main conveying direction. This ejection function also comes into play when the belt buffer is full and the overflow needs to be ejected.

If the belt buffer is positioned at the beginning of a product line or in the middle of the line, the product flow is driven through the buffer according to the FiFo principle. In this case, the incoming product rows are fed via inlet conveyors 3, 3′ and taken over by a buffer conveyor level. The product rows are synchronized at a definable distance from one another until a buffer belt level is completely filled and the discharge process can be started. The switch at the inlet then switches to the next free buffer belt level, which can then receive the product rows coming from production. This means that the inlet of the belt buffer and the outlet of the belt buffer are decoupled from one another because product rows entering and product rows leaving the belt buffer are always handled by different buffer belt levels. This also makes it possible to increase the speed of the outlet, which is typical for dynamic buffers, depending on the buffer filling level, using the buffer control 8.

If the belt buffer is positioned at the end of the line, it can also be operated according to the advantageous FiFo principle according to the invention. The belts located above the feed level serve as buffer belts on which the incoming product rows are clocked in the main transport direction. If a buffer belt is full, the front first belt switch at the inlet switches to another empty buffer belt and can thus continue to accommodate the incoming product flow. During this time, the product rows on the already filled buffer belts can be transferred to the lowest buffer belt level via the rear second belt switch and the downstream reversible outlet belt 4. The product rows return to the inlet via this lowest belt level and can be conveyed back to the upstream inlet belt by switching the inlet switch. The products are returned on the lowest buffer belt level against the main transport direction. Thus, the incoming product flow is buffered on the buffer belts located above the inlet level in the main transport direction and then diverted via the rear second belt switch to the lowest buffer belt level before returning to the inlet side against the main transport direction.

This avoids constant reversing on the buffer belts, and the product flow is guided through the belt buffer according to the FiFo principle. Reversing is reduced to belts 3 and 4 upstream and downstream of the belt buffer. However, since these belts are horizontal, reversing operation is not as critical as with inclined belts, since the adhesion of the products on the horizontal belts is maximum. This greatly reduces the risk of product rows slipping and thus massively increases the efficiency of the belt buffer.

### LIST OF REFERENCE SIGNS

1 conveyor belt
2 conveyor belt
3,3′ inlet belt
4,4′ outlet belt
5, 5′, 5″, 5′″ inlet-side belt deflectors
6, 6′, 6″, 6′″ outlet-side belt deflectors
7 chassis
8 control unit
9 discharge conveyor
10, 10′, 10″, 10′″ drive
11 lifting mechanism
2, 12′ coupling struts
3, 13′ products
4 gap
T main transport direction

1. Belt buffer for a product conveying device which conveys products (13) from a production facility by means of conveyor belts (1, 2) to at least one further processing facility, the belt buffer having at least two buffer belts, which store products (13) and are arranged vertically one above the other, the buffer belts each having a vertically pivotable belt deflector for selectively connecting to a conveyor belt, characterized in that, the buffer belts each comprising a first vertically pivotable belt deflector (5) on the inlet side, for selectively connecting to an inlet belt (3), and a second vertically pivotable belt deflector (6) on the outlet side for selectively connecting to an outlet belt (4),
characterized in that
the buffer belts each have a horizontal stationary conveyor chassis (7), on one side of which the inlet-side belt deflector (5) and on the other side of which the outlet-side belt deflector (6) are pivotally mounted.

2. Belt buffer according to claim 1, comprising an inlet belt (3) and an outlet belt (4), wherein the inlet belt (3), the buffer belts and the outlet belt (4) are arranged in series one behind the other.

3. Belt buffer according to either claim 1, characterized in that the inlet-side belt deflector (5) and the outlet-side belt deflector (6) can be controlled independently of one another, in particular can be pivoted independently of one another.

4. Belt buffer according to claim 1, characterized in that at least two belt deflectors (5, 5′; 6, 6′) arranged vertically one above the other are coupled to one another.

5. Belt buffer according to claim 1, characterized in that the inlet belt (3) and the outlet belt (4) are arranged on one level.

6. Belt buffer according to claim 1, characterized in that pivotable regions of the buffer belts, which are arranged below a level of the inlet belt (3) and/or the outlet belt (4), are designed as autonomous conveyor belts.

7. Belt buffer according to claim 1, characterized in that at least the lowermost of the buffer belts and the outlet belt (4) are designed to be reversibly drivable.

8. Belt buffer according to claim 1, characterized in that the inlet-side belt deflectors (5) can be pivoted vertically over the inlet belt.

9. Belt buffer according to claim 1, characterized in that two inlet belts (3, 3′) and/or two outlet belts (4, 4′) are each arranged vertically one above the other, each of the inlet belts and/or the outlet belts being connectable to at least two inlet-side belt deflectors (5) or outlet-side belt deflectors (6) arranged one above the other.

10. The product conveying device according to claim 1, where the product conveying device conveys products (13) from a production facility along a production line by means of conveyor belts (1, 2) to at least one further processing facility and has a belt buffer in the conveyor line for temporarily storing products (13).

11. Product conveying device according to claim 10, characterized in that the belt buffer is provided between the production facility and the further processing facility and an inlet conveying direction from the production facility corresponds to an outlet conveying direction to the further processing facility.

12. Product conveying device according to claim 10, characterized in that the belt buffer is provided at the end of the conveyor line behind the production facility and behind product discharge stations which divert products from the conveyor line to a further processing facility, and in that an outlet conveying direction from the belt buffer is opposite to an inlet conveying direction into the belt buffer.

13. Method for temporarily storing products (13) during product conveyance by a product conveying device according to claim 10, wherein a product inlet into the belt buffer and a product outlet from the belt buffer takes place from different buffer belts arranged vertically one above the other.

14. Method for temporarily storing products according to claim 13, wherein products (13) are fed to the belt buffer via the inlet belt (3) in a conveying direction to an inlet-side belt deflector (5) of a buffer belt, and products (13) from another buffer belt are discharged via the outlet-side belt deflector (6) of the other buffer belt via the outlet belt (4) in the same or opposite conveying direction.

15. Method for temporarily storing products according to claim 13, wherein storing in the belt buffer and removing from the belt buffer are controlled independently of one another.
